(19) United States
(12) Patent Application Publication
(10) Pub. No.: US 2010/0023956 A1
(43) Pub. Date: Jan. 28, 2010

(54) METHODS FOR IMPLEMENTATION OF AN EJECT SERVICE FOR A REMOVABLE DISK DRIVE

(75) Inventors: Matthew D. Bondurant, Superior, CO (US); Chris Mayne, Boulder, CO (US); Payman Dadashpour, Boulder, CO (US); James D. Jones, Niwot, CO (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: ProStor Systems, Inc., Boulder, CO (US)

(21) Appl. No.: 12/180,147

(22) Filed: Jul. 25, 2008

(51) Int. Cl. G11B 17/03

(52) U.S. Cl. 720/601

(57) ABSTRACT

Embodiments provide systems and methods for ejecting a removable disk drive. To prevent data corruption from the eject operation, a shell extension can be stored in the server requesting the eject. The shell extension can monitor and intercept eject commands from the operating system of the server and send the commands to an eject service. The eject service, in embodiments, checks the status of the removable disk drive and ejects the removable disk drive only when the removable disk drive is not busy with another operation.

### BACKGROUND

Embodiments of the disclosure generally relate to storage systems and, more specifically, but not by way of limitation, to archiving storage systems.

Governments and other organizations often require the storage of certain types of data for long periods. For example, the Securities and Exchange Commission (SEC) may require retention of financial records for three or more months. Thus, entities that have to meet these storage requirements employ archiving systems to store the data to a media allowing for long-term storage. The systems, in some situations, employ removable disk drives.

Further, the archiving systems may employ a file system to electronically organize and store the material to the removable disk drives. In some situations, the file system allows for the disk drive to be ejected. However, in some situations, the file system allows the disk to be ejected while the disk is performing a function to the data on the disk. These occurrences generally result in corrupted data on the disk. Corrupted data is avoided in these archiving systems because the data may be required in future retrievals.

It is in view of these and other considerations not mentioned herein that the embodiments of the present disclosure were envisioned.

### BRIEF SUMMARY

Embodiments of the present disclosure provide unique and novel systems and methods for ejecting removable disk drives. The removable disk drives described are controlled by an operating system that allows eject operations. However, a separate eject service monitors such operations and intervenes if the disk is in operation. The eject service waits for a period of time to allow the disk to finish the operation. After the operation is finished, the eject service allows the eject. As such, data corruption is avoided and the disk eject command occurs. Alternative systems and methods are also presented.

### BRIEF DESCRIPTION OF THE DRAWINGS

The embodiments of the present disclosure are described in conjunction with the appended figures:

FIG. 1 is a block diagram of an embodiment of a removable cartridge storage system;

FIG. 2 is a hardware block diagram of an embodiment of an archiving system including one or more removable cartridge storage systems;

FIG. 3 is a functional block diagram of an embodiment of an archiving system;

FIG. 4 is a hardware block diagram of an embodiment of a modular drive bay having two or more removable disk drives;

FIG. 5 is a functional block diagram of an embodiment of a modular drive bay;

FIGS. 6A and B are block diagrams of embodiments of software modules for an eject service to complete ejects of removable disk drives;

FIGS. 7A and 7B are flow diagrams of an embodiment of a method for ejecting a removable disk drive;

FIG. 8 is flow diagram of another embodiment of a method for ejecting a removable disk drive; and

FIG. 9 is a flow diagram of an embodiment of a method for ejecting a removable disk drive.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

The ensuing description provides exemplary embodiment(s) only and is not intended to limit the scope, applicability or configuration of the possible embodiments. Rather, the ensuing description of the exemplary embodiment(s) will provide those skilled in the art with an enabling description for implementing one or more embodiments. It being understood that various changes may be made in the function and arrangement of elements without departing from the spirit and scope of the possible embodiments as set forth in the appended claims.

Embodiments disclosed herein provide an eject service in communication with a file system. The file system may be, for example, Microsoft's® NT File System. Other file systems are possible. The file system allows ejects of a removable disk drive from a disk drive bay. The eject, in embodiments, is requested from a user interface interaction or from the engagement of a mechanical device, for example, an eject button. The file system, in response to the eject request, may attempt to eject the removable disk drive. In embodiments, the eject service monitors the file system and determines the file system is attempting an eject. The eject service can intervene to intercept commands or requests going to or coming from the file system. Embodiments of the eject service determine a condition of the removable disk drive, for example, is the removable disk drive writing data to the drive. If an operation is occurring that, if interrupted, will result in data corruption, the eject service can delay the eject command. After the operation is complete, the eject service can allow the eject. In the following description, exemplary embodiments of the archiving system with removable disk drives are described.

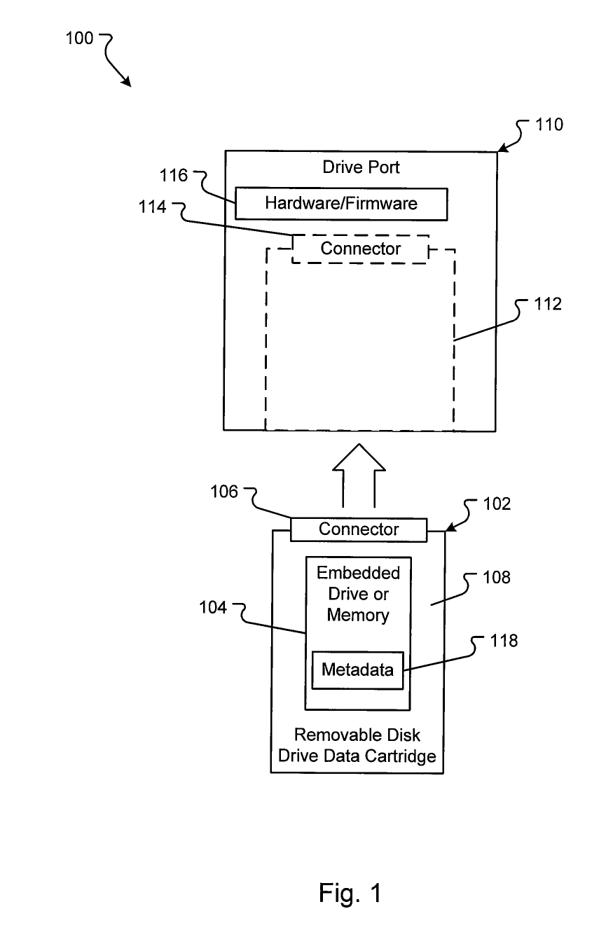

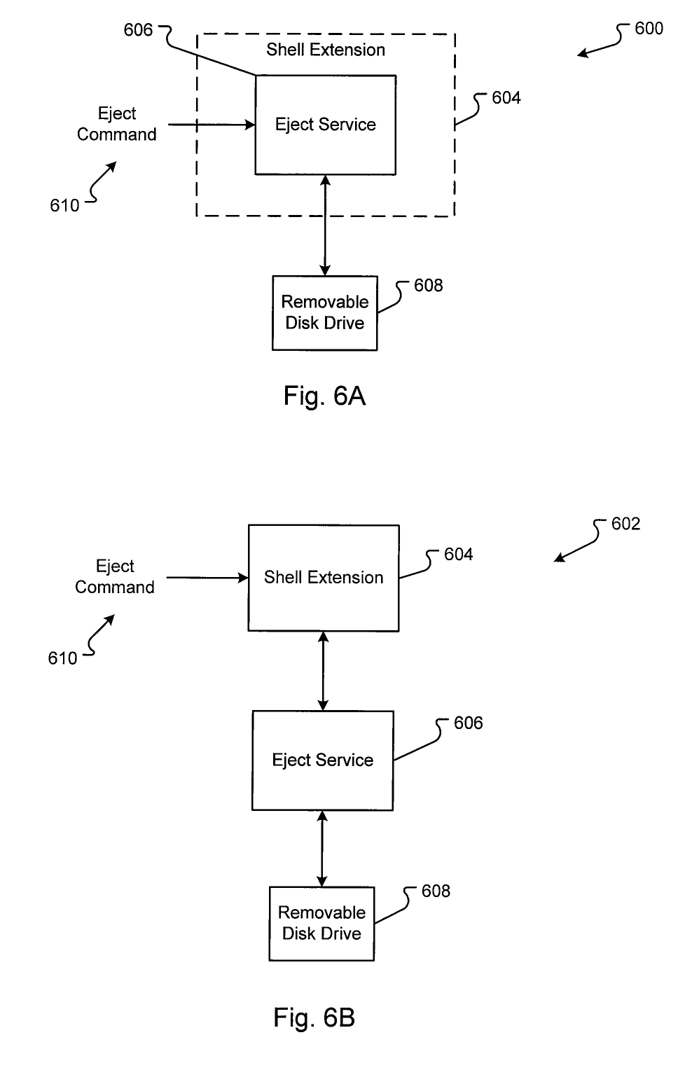

An embodiment of a removable disk system 100 to provide long-term archival data storage is shown in FIG. 1. The removable disk system 100 and description related to the removable disk system is being provided as one or many possible removable disk systems that could use an eject service. In embodiments, the eject service is executed in a server that is in communication with the removable disk system, as explained in conjunction with FIGS. 6A through 9. A removable disk drive 102 provides storage capability for the removable disk system 100. In embodiments, the removable disk drive 102 includes a data cartridge case 108 and an embedded memory 104, which may be one of, but is not limited to, an embedded hard disk drive (HDD), solid state disk (SSD), solid state drive, or flash memory. The HDD or flash memory 104 provides RAM for the storage of archived data. The embedded memory 104 is in communication with and/or electrically connected to a connector 106. In one embodiment, the connector is a Serial Advanced Technology Attachment (SATA) connector. In other embodiments, the connector is a Universal Serial Bus (USB) connector, parallel connector, Firewire connector, or other connector. Both the embedded memory 104 and connector 106 are, in embodiments, physically attached to the data cartridge case 108, and, in some embodiments, enclosed, protected, connected or integrated by the data cartridge case 108. In other embodiments, the embedded memory 104 and the connector 106 are a physically integrated component and the connector 106 protrudes from the data cartridge case 108. The data cartridge case 108, in embodiments, provides a solid container for the embedded memory 104 that also functions as an easily swappable or changed case when interchanging removable disk drives 102 in the removable disk system 100.

The embedded memory 104, in embodiments, includes metadata 118. Metadata 118, in embodiments, allows the archiving system to provide different functionality with the removable disk drive 102. Metadata 118 can include any information about the data stored in the memory 104. The information can include memory addresses, protection formats for the data, encryption keys, etc. With the metadata 118 stored in the embedded memory 104, the removable disk drive 102 may be physically stored apart from the removable disk drive system 102 and allow the removable disk drive 102 to be later reinserted with the same functionality.

In embodiments, the removable disk system 100 contains a drive port 110 that includes one or more data cartridge ports 112, each with a data cartridge connector 114 to receive the removable disk drive 102. The data cartridge connector 114 mates with the electrical connector 106 of the removable disk drive 102 to provide an electrical connection to the removable disk drive 102 and/or to communicate with the embedded memory 104 in the removable disk drive 102. As with the electrical connector 106, the data cartridge connector 114 may be a SATA connector or another type of connector. Regardless, the data cartridge connector 114 and the electrical connector 106 can be physically and/or electrically connected. The data cartridge port 112 allows the data cartridge case 108 of the removable disk drive 102 to be easily inserted and removed as necessary. In embodiments, the drive port 110 includes two or more data cartridge ports 112 to allow for the use, control and communication with two or more removable disk drives 102. Each drive port 110, in embodiments, is separately addressable to allow for customized control over each removable disk drive 102 connected to each data cartridge port 112. Thus, as removable disk drives 102 are replaced, the same controls can be applied to the newly inserted removable disk drives 102 because the drive port 110 is addressed instead of the removable disk drives 102. In embodiments, the removable disk drives 102 can be ejected from the drive port 110 upon issuance of an ejection command. The ejection command may be issued by a software system or be issued in response to the mechanical engagement of a physical ejection button or interface.

The embedded memory 104 may be read and used by the hardware/firmware 116 of the drive port 110. The hardware/firmware 116 may be hardware and/or software resident in the drive port 110 for controlling the removable disk drive 102. In embodiments, the hardware/firmware 116 contains the necessary software and/or hardware to power-up the removable disk drive 102, spin-up the disk platters in the embedded memory 104, read and write to the embedded memory 104, read, write and process metadata 118, etc. For example, the hardware/firmware 116 could read the embedded memory 104 to identify the removable disk drive 102 and gather information related to the drive's contents.

In embodiments, the removable disk system 100 operates to receive one or more removable disk drives 102 in the one or more drive ports 110. The electrical connector 106 physically connects or couples with the data cartridge connector 114 to form an electrical connection that allows the drive port 110 to communicate with the embedded memory 104. The hardware/firmware 116 powers-up the embedded memory 104 and begins any initialization processes (e.g., security processes, identification processes, reading and/or writing, etc.). The drive port 110, which, in embodiments, is in communication with a network, receives archival data from one or more servers, applications, or other devices or systems on the network. The hardware/firmware 116 writes the archival data to the embedded memory 104 of the removable disk drive 102 to archive the data.

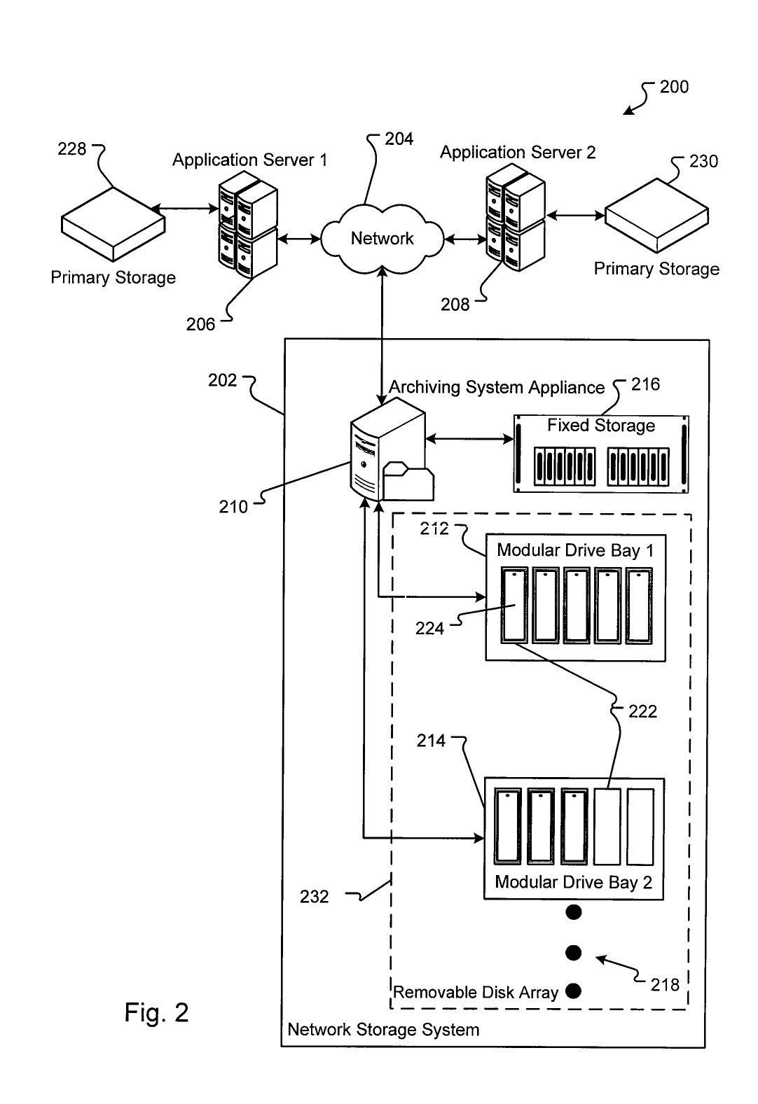

An embodiment of the hardware architecture of an archiving system 200 is shown in FIG. 2. The archiving system 200, in embodiments, comprises a network storage system 202 in communication with one or more systems via a network 204. In embodiments, the systems that communicate with the network storage system 202 comprise applications, application servers, other servers, peripherals, other devices, and other systems that archive data on the network storage system 202. For example, application server 1 206 and/or application server 2 208 store archival data on the network storage system 202. The application servers 206 and/or 208 can execute the eject service. An application server 206 or 208 may be an application, peripheral device, system, network component, or other software function or hardware device that may store archived data. Hereinafter, all functions, systems, processes, hardware devices that may store archived data will be referred to as an application or application server. Application server 1 206 and application server 2 208 will hereinafter be used to describe the functions of the archiving system 200 but are not meant to limit the description to the exemplary embodiments set forth herein.

The network storage system 202 comprises one or more components that may be encompassed in a single physical structure or be comprised of discrete components. In embodiments, the network storage system 202 includes an archiving system appliance 210 and one or more removable disk drives 224, which may be the same or similar to removable disk drive 102 (FIG. 1), connected or in communication with a drive port 222, which may be the same or similar to drive port 110 (FIG. 1). In alternative embodiments, a modular drive bay 212 and/or 214 includes two or more drive ports 222 that can each connect with a removable disk drive 224. Thus, the modular drive bays 212 and 214 provide added storage capacity because more than one removable disk drive 224 can be inserted and accessed using the same archiving system appliance 210. Further, each drive port 222 in the modular drive bays 212 and 214 are, in embodiments, separately addressable allowing the archiving system appliance 210 to configure the removable disk drives 224 in the modular drive bays 212 and 214 into groups of one or more removable disk drives 224. Two or more modular drive bays 212 and 214, in embodiments, are included in the network storage system 202, as evidenced by the ellipses 218. Thus, as more data storage capacity is required, more modular drive bays 212 and 214 may be added to the network storage system 202. In embodiments, each modular drive bay 212 and 214 may include a single hardware/firmware 116 (FIG. 1) for all drive ports 222 in the modular drive bays 212 and 214. In alternative embodiments, each drive port 222 includes hardware/firmware 116 (FIG. 1).

The exemplary hardware architecture in FIG. 2 provides near limitless capacity as more removable disk drives 224 can be added to existing modular drive bays 212 or 214 until the modular drive bays 212 and 214 hold all possible removable disk drives 224. Then, more modular drive bays 212 and 214 are added to the network storage system 202. Further, removable disk drives 224 may be replaced as the removable disk drives 224 near their storage capacity. The removed disk drives 224, in embodiments, are physically stored if and until the data on the removable disk drives 224 needs to be retrieved. If the data on the removable disk drive 224 needs to be retrieved, the removable disk drive 224 may be inserted into one of the drive ports 222 of the modular drive bay 212 or 214, and the information retrieved from the connected removable disk drive 224.

The archiving system appliance 210, in embodiments, is a server operating as a file system. The archiving system appliance 210 may be any type of computing system having a processor and memory and operable to complete the functions described herein. An example of a server that may be used in the embodiments described herein is the PowerEdge™ 2950 Server offered by Dell Incorporated of Austin, Tex. The file system executing on the server may be any type of file system, such as the NT File System (NTFS), that can complete the functions described herein. Hereinafter, the archiving system appliance 210 may be referred to as the host.

In embodiments, the two or more modular drive bays 212 and/or 214, having each one or more inserted removable disk drives 224, form a removable disk array (RDA) 232. The archiving system appliance 210 can configure the RDA 232 into one or more independent file systems. Each application server 206 or 208 requiring archiving of data may be provided a view of the RDA 232 as one or more independent file systems. In embodiments, the archiving system appliance 210 logically partitions the RDA 232 into application layer partitions and logically associates one or more drive ports 222 with each application layer partition. An application layer partition is associated with the application server 206 or 208 rather than some arbitrary logical divisions. Thus, the one or more removable disk drives 224 comprising the application layer partition appears as an independent file system.

In further embodiments, the archiving system appliance 210 provides an interface for application server 1 206 and application server 2 208 that allows the application servers 206 and 208 to communicate archival data to the archiving system appliance 210. The archiving system appliance 210, in embodiments, determines where and how to store the data to one or more removable disk drives 224. For example, the application server 1 206 stores archival data in a first application layer drive, such as, the first three removable disk drives. The application layer drives are, in embodiments, presented to the application servers 206 and 208 as application layer drives where write and read permissions for any one application layer drive is specific to one of the application servers. As such, the network storage system 202 provides a multiple and independent file system to each application server 206 and 208 using the same hardware architecture. In embodiments, the archival data is also referred to as an information element and may include, but is not limited to, a file, a memory sector, a data structure, a table, or other type or format of data.

In alternative embodiments, the network storage system 202 also comprises a fixed storage 216. The fixed storage 216 may be any type of memory or storage media either internal to the archiving system appliance 210 or configured as a discrete system. For example, the fixed storage 216 is a Redundant Array of Independent Disks (RAID), such as the Xtorc XJ-SA12-316R-B from AIC of Taiwan. The fixed storage 216 provides an active archive for storing certain data for a short period of time where the data may be more easily accessed. In embodiments, the archiving system appliance 210 copies archival data to both the fixed storage 216 and the removable disk drive 224. If the data is needed in the short term, the archiving system appliance 210 retrieves the data from the fixed storage 216. The archiving system appliance 210, in embodiments, sends the archival data to or removes the archival data from the modular drive bay 212 or 214 having a predetermined address to store or retrieve the archival data from a removable disk drive 224.

The archiving system appliance 210 can also configure the active archive in the fixed storage 216 into one or more independent file systems, as with the RDA 232. As explained above, each application server may be provided a view of one of two or more independent file systems. Each independent file system may comprise an application layer partition in the RDA 232 and a related application layer partition in the fixed storage 216. In embodiments, the archiving system appliance 210 partitions the fixed storage 216 and associates each application layer partition in the fixed storage 216 with an associated application layer partition in the RDA 232.

As explained above, the archiving system appliance 210, in embodiments, determines where and how to store the data to one or more removable disk drives 224. For example, the application server 1 206 stores archival data in a first application layer drive, which may include storing the archival data in the application layer partition in the fixed storage 216 for easier access to the archival data. Again, the application layer drives are, in embodiments, presented to the application servers 206 and 208 where write and read permissions for any one application layer drive is specific to one of the application servers. As such, the network storage system 202 provides a multiple and independent file system to each application server 206 and 208 using the same hardware architecture.

In operation, application server 1 206 stores primary data into a primary storage 228, which may be a local disk drive or other memory. After some predetermined event, the application server 1 206 reads the primary data from the primary storage 228, packages the data in a format for transport over the network 204 and sends the archival data to the network storage system 202 to be archived. The archiving system appliance 210 receives the archival data and determines where the archival data should be stored. The archival data, in embodiments, is then sent to the related application layer partitions in both the fixed storage 216 and the RDA 232, which may comprise one or more of the removable disk drives 224 in one or more of the drive ports 222. The archiving system appliance 210 can retrieve or receive a memory address(es) for the data to be stored in the removable disk drive 224. The archival data is written to the removable disk drive 224 for long-term storage and is written to the fixed storage 216 for short-term, easy-access storage. In further embodiments, application server 2 208 writes primary data to a primary storage 230 and also sends archival data to the network storage system 202. In some embodiments, the archival data from application server 2 208 is stored to a different removable disk drive 224 and a different portion of the fixed storage 216 because the archival data from application server 2 208 relates to a different application and, thus, a different application layer partition.

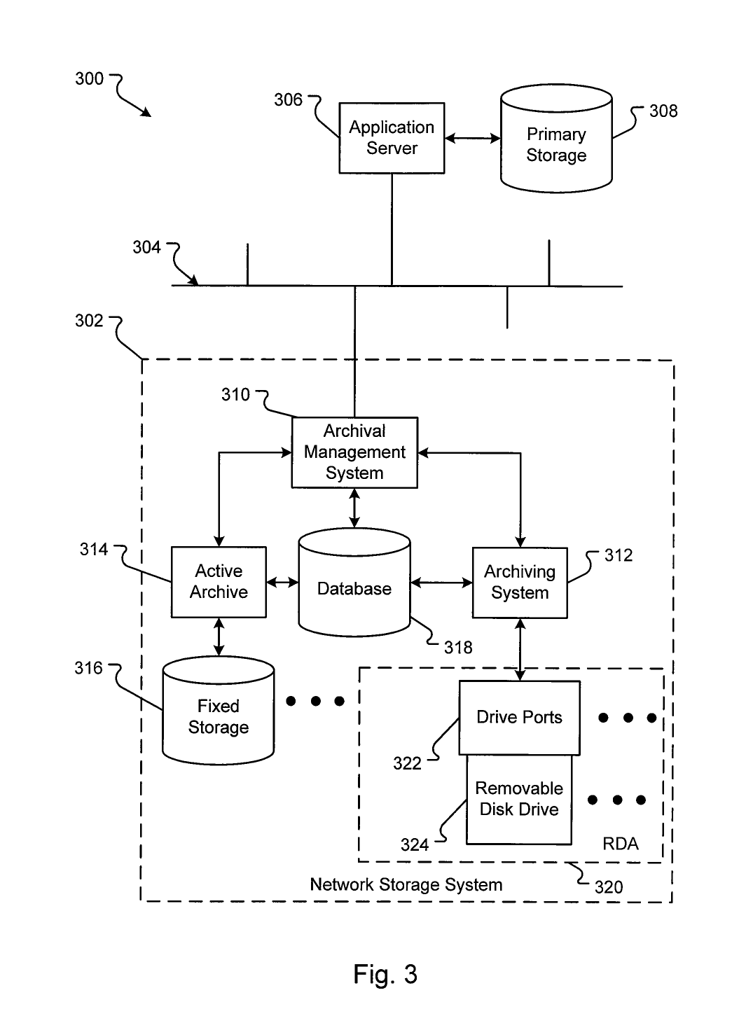

A block diagram of an archiving system 300 is shown in FIG. 3. The archiving system 300 has one or more functional components that, in embodiments, includes a network storage system 302 in communication with a network 304. The network 304 may be any type of communication infrastructure, for example, one or more of, but not limited to, a wide-area network (WAN), local area network (LAN), wireless LAN, the Internet, etc. The network storage system 302 may communicate with one or more other systems coupled to, connected to, or in communication with the network 304. For example, the network storage system 302 communicates with an application server 306. Communications between systems on the network 304 may occur by any protocol or format, for example, Transmission Control Protocol/Internet Protocol (TCP/IP), Hyper Text Transfer Protocol (HTTP), etc.

The network storage system 302, in embodiments, comprises one or more functional components embodied in hardware and/or software. In one embodiment, the network storage system 302 comprises an archiving system 312 in communication with one or more drive ports 322 that are in communication with one or more removable disk drives 324. The drive ports 322 and removable disk drives 324 are the same or similar in function to those described in conjunction with FIGS. 1 and 2. The archiving system 312 controls the function of the one or more drive ports 322 and writes the archived data to one or more predetermined removable disk drives 324 in the one or more drive ports 322.

In further embodiments, the network storage system 302 comprises an archival management system 310. The archival management system 310 receives data for archiving from one or more systems on the network 304. Further, the archival management system 310 determines to which system or removable disk drive 324 the data should be archived, in which format the data should be saved, and how to provide security for the network storage system 302. In embodiments, the archival management system 310 provides a partitioned archive such that the network storage system 302 appears to be an independent file system to each separate application server 306, yet maintains the archive for multiple application servers 306. Thus, the archival management system 310 manages the network storage system 302 as multiple, independent file systems for one or more application servers 306. In embodiments, the archival management system 310 and the archiving system 312 are functional components of the archiving system appliance 210 (FIG. 2).

In embodiments, the archival management system 310 saves archival data to both the archiving system 312 and an active archive 314. The active archive 314, in embodiments, controls, reads from and writes to one or more fixed storage devices 316 that allow easier access to archived data. In embodiments, fixed storage 316 is similar in function to fixed storage 216 (FIG. 2). The active archive 314 performs similar functions to the archiving system 312 but for the fixed storage devices 316. In embodiments, the active archive 314 and the fixed storage devices 316 are components of the hardware fixed storage system 216 (FIG. 2). In alternative embodiments, the active archive 314 partitions the fixed storage 316 to mirror the associated application layer partitions in the RDA 320. The application layer partition(s) in the active archive 314 may have boundaries associated with memory addresses in the fixed storage 316.

The archival management system 310 may also provide an intelligent storage capability. Each type of data sent to the network storage system 302 may have different requirements and controls. For example, certain organizations, such as the SEC, Food and Drug Administration (FDA), European Union, etc., have different requirements for how certain data is archived. The SEC may require financial information to be kept for seven (7) years while the FDA may require clinical trial data to be kept for thirty (30) years. Data storage requirements may include immutability (the requirement that data not be overwritten), encryption, a predetermined data format, retention period (how long the data will remain archived), etc. The archival management system 310 can apply controls to different portions of the RDA 320 and the active archive 314 according to user-established data storage requirements. In one embodiment, the archival management system 310 creates application layer partitions in the archive that span one or more removable disk drives 324 and one or more portions of the fixed storage 316. All data to be stored in any one application layer partition can have the same requirements and controls. Thus, requirements for data storage are applied to different drive ports 222 (FIG. 2) in the modular drive bays 212 and 214 (FIG. 2) and to the removable disk drives 224 (FIG. 2) stored in those drive ports 222 (FIG. 2). Further, the requirements are likewise applied to different portions of the fixed storage 316 in the active archive 314. If a removable disk drive 324 is replaced, the same storage requirements, in embodiments, are applied to the replacement removable disk drive 324 because of its location in the controlled drive port 322. As such, the archival management system 310 can individually maintain separate sets of data using different controls, even in different removable disk drives 324. Still further, the importance of maintaining the data requires that the data not be corrupted or deleted accidentally. As such, special controls are applied to actions, such as the ejection of the removable disk drives 324, that protect the integrity of the data.

The network storage system 302 may also comprise a database 318 in communication with the archival management system 310. The database 318 is, in embodiments, a memory for storing information related to the data being archived. The database 318 may include HDDs, ROM, RAM or other memory either internal to the network storage system 302 and/or the archival management system 310 or separate from the network storage system 302 and/or the archival management system 310, as a discrete component addressable by the archival management system 310. The information stored in the database 318, in embodiments, includes one or more of, but is not limited to, data identification, application server identification, time of storage, removable disk drive identification, data format, encryption keys, application layer partition organization, etc.

The network 304, in embodiments, connects, couples, or otherwise allows communications between one or more other systems and the network storage system 302. For example, the application server 306 is connected to the network storage system 302 via the network 304. The application server 306 may be a software application, for example, an email software program, a hardware device, or other network component or system. The application server 306, in embodiments, communicates with a memory that functions as the application server's primary storage 308. The primary storage 308 is, in embodiments, an HDD, RAM, ROM, or other memory either local to the application server 306 or in a separate location that is addressable.

In embodiments, the application server 306 stores information to the primary storage 308. After some predetermined event, such as the expiration of some period of time, the application server 306 sends data to the network storage system 302 to archive the data. The application server 306 may send the data by any network protocol, such as TCP/IP, HTTP, etc., over the network 304 to the network storage system 302. The data is received at the archival management system 310. The archival management system 310, in embodiments, sends the data to one or both of the active archive 314 and/or the archiving system 312 to be archived.

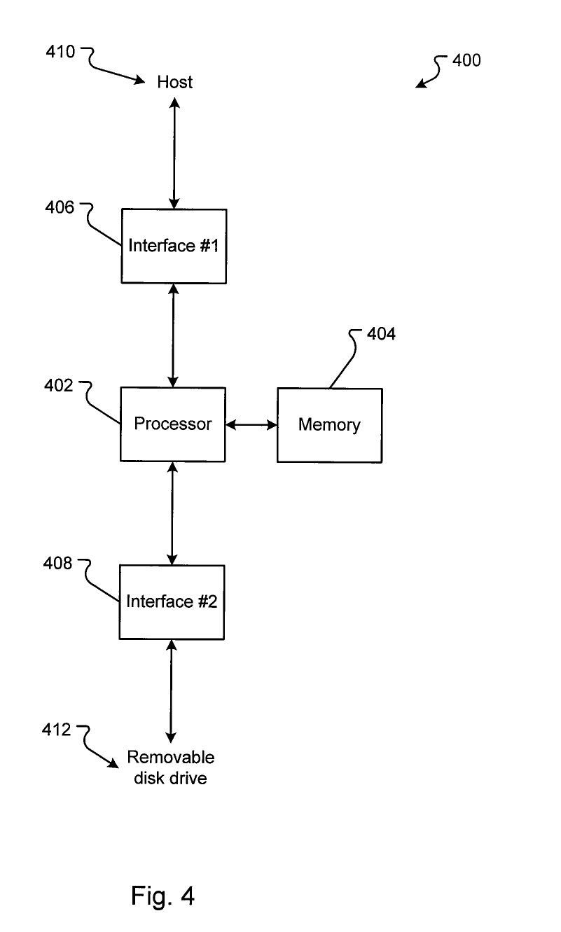

Embodiments of the hardware/firmware 400 of the modular drive bay is shown in FIG. 4. In embodiments, the hardware/firmware 400 is the same or similar to hardware/firmware 116 explained in conjunction with FIG. 1. The hardware/firmware 400, in embodiments, comprises a first interface (interface #1) 406, a processor 402, a memory 404, and a second interface (interface #2) 408. In embodiments, the first interface 406 receives archival data from the host 410 for storage in a removable disk drive 412 and/or sends archived data from the removable disk drive 412 to the host 410. Removable disk drive 412 is, in embodiments, the same or similar to removable disk drive 102 described in conjunction with FIG. 1. The first interface 406 can be any type of interface operable to communicate with the host 410. In embodiments, the host 410 is the archiving system appliance 210 (FIG. 2) and/or archiving system 312 (FIG. 3). The first interface 406 can be a Firewire, USB, SATA, or other interface.

The processor 402 is operable to execute software or firmware stored in memory 404 for storing or retrieving archival data from the removable disk drive 412. The processor 402, in embodiments, is any processor known in the art for executing the functions described herein. For example, the processor 402 is an Intel Pentium, ASIC, FPGA, or other device. The processor 402 interfaces with the first interface 406 to receive archival data for storage and to send data requested from the host 410. The processor 402 further interfaces with the second interface 408 to send data to the removable disk drive 412 and to read data from the removable disk drive 412. The memory 404 may be any type of memory including RAM, ROM, disk drive, etc. The memory 404 may store data or metadata and interfaces with the processor 402.

In embodiments, the second interface 408 retrieves archival data from the removable disk drive 412 to send to the host 410 and sends archival data to the removable disk drive 412 for storage. The second interface 408 can be any type of interface operable to communicate with the removable disk drive 412. The second interface 408 can be a Firewire, USB, SATA, small computer system interface (SCSI), or other interface.

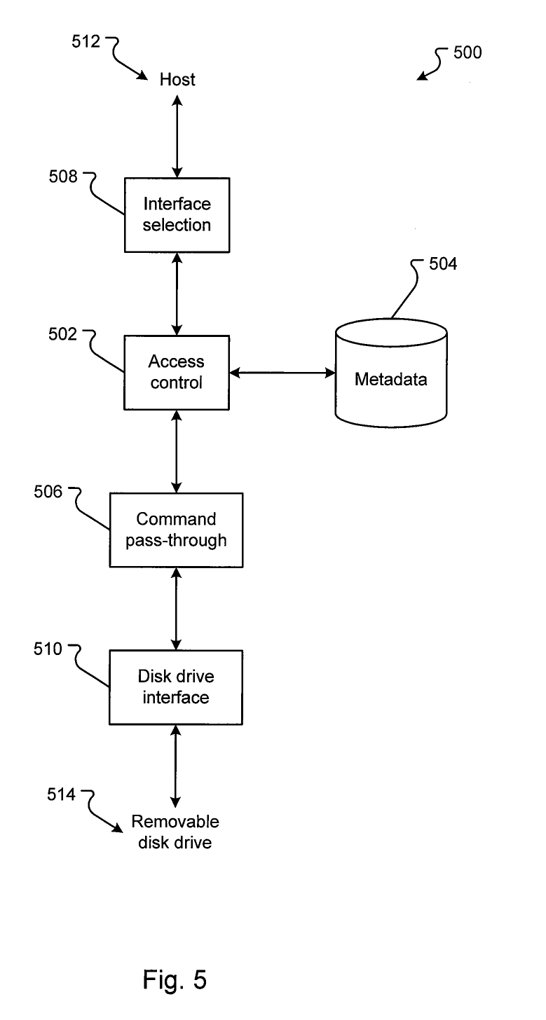

A functional block diagram of an embodiment of the hardware/firmware 500 of the modular drive bay is shown in FIG. 5. In embodiments, the hardware/firmware 500 is the same or similar to hardware/firmware 116 explained in conjunction with FIG. 1 or hardware/firmware 400 described in conjunction with FIG. 4. In embodiments, the hardware/firmware 500 represents software executed in the hardware/firmware 400 (FIG. 4). The hardware/firmware 500, in embodiments, comprises an interface selection module 508, an access control module 502, a metadata datastore 504, a command pass-through module 506, and/or a disk drive interface 510.

In embodiments, the interface selection module 508 receives requests from the host 512 to store or retrieve archival data. The host 512 may send the requests with a predetermined address for the archival data. The interface selection module 508 can extract the address received from the host 512 to which to store or retrieve the archival data. This address is, in embodiments, provided to the access control module 502.

The access control module 502 is operable to read metadata from the metadata datastore 504. The access control module 502, in embodiments, builds the metadata datastore 504 by reading the metadata from the one or more removable disk drives 514 and storing the metadata in a table or other data structure in the metadata datastore 504. In embodiments, the metadata datastore 504 provides a first available block address to store data in a removable disk drive 514. The first available block address can be used by the access control module 502 to determine where to begin to store data. The access control module 502 can be executed within the processor 402 (FIG. 4).

In embodiments, the command pass-through module 506 sends the commands to the removable disk drive 514. For example, if the request from the host 512 is for a read of data, the command pass-through module 506 executes a read on the removable disk drive 514. The requested command sent from the host 512 may be in one format or comply with one file system. The command pass-through module 506 may change the command to a command understandable by the removable disk drive 514. In further embodiments, the access control module 502 provides the command pass-through module 506 with the first available block address to ensure the command pass-through module 506 stores data at the correct address in the removable disk drive 514.

The disk drive interface 510, in embodiments, is a disk drive driver or other software that allows the command pass-through module 506 to interface with the removable disk drive 514. Thus, the disk drive interface 510 may convert commands for the removable disk drive 514. In alternative embodiments, the disk drive interface 510 also receives inputs from the removable disk drive 514. For example, if a mechanical eject button is depressed, the removable disk drive 514 or the drive port 110 (FIG. 1) holding the removable disk drive 514 sends the eject signal to the disk drive interface 510. The disk drive interface 510 may then send the eject signal to the access control module 502.

Two embodiments of software systems 600 and 602 for ejecting a removable disk drive 608 are shown in FIGS. 6A and 6B, respectively. The software systems 600 and/or 602 can execute in a server or computing system in communication with a removable disk drive system. The eject service 606 may be a component of the application server 206 (FIG. 2). In other embodiments, the eject service 606 may execute in the archival management system 310 (FIG. 3) and/or the archiving system 312 (FIG. 3). The eject service is the one or more software and or hardware components operable to eject a removable disk drive 608 and/or send, receive, or operate on eject commands, whether hardware signals and/or software calls. In embodiments, an eject service 606 includes operations to execute an eject command 610 or directive.

The eject service 606, in one embodiment, may execute in a shell extension 604, as shown in FIG. 6A. In an alternative embodiment, the shell extension 604 executes as a separate component in communication with the eject service 606, as shown in FIG. 6B. The shell extension 604 may be software and/or hardware operable to monitor the commands from the operating system and/or user interface of the server 206 (FIG. 2) and react to those commands in one or more predetermined ways. For example, the shell extension 604 intercepts eject commands 610 from the operating system and sends the commands to the eject service 606 to prevent data corruption or execute the eject. In embodiments, the shell extension 604 executes in the server 206 (FIG. 2), and, in other embodiments, the shell extension 604 executes in the archival management system 310 (FIG. 3), the archiving system 312 (FIG. 3), the processor 402 (FIG. 4), the access control module 502 (FIG. 5), and/or the command pass through module 506 (FIG. 5).

The eject command 610 may be issued in one or several ways. In one embodiment, a user chooses to eject a removable disk drive 608 using a user interface. The eject command 610 may be received from a user interface device, such as a mouse or keyboard, interacting with a user interface device, such as an window icon. In other embodiments, the eject command 610 is a hardware signal from a mechanical device, such as an eject button. The hardware signal may be passed to the operating system and onto the eject service 606 by one or more components, such as the disk drive interface 510 (FIG. 5).

In operation, the eject service 606 receives the eject command 610. The shell extension 604 monitors the commands being issued to the removable disk drive 608. For example, the shell extension 604 reads the commands in the software stack of the operating system before being issued. In response to the issuance of the eject command 610 by the operating system, the shell extension 604 intercepts the eject command 610 and passes the command to the eject service 606. The eject command 610 may have been from a user interface or a hardware device. The eject service 606 determines the removable disk drive 608 to eject and sends a signal to a drive, for example, the drive port 110 (FIG. 1), to eject the removable disk drive 608. Then, the eject service 606 determines if the removable disk drive 608 is busy, for example, completing an operation, which if interrupted, could cause data corruption or other problems. If there is no operation being completed or if the operation can be interrupted, the eject service 606 forwards the eject command 610 to the drive to eject the removable disk drive 608. However, if the removable disk drive 608 is executing an operation, which if interrupted, would cause data corruption or other problems, the eject service 606 holds the command for a predetermined period of time. After the operation is complete, the eject service 606 can send the eject command 610 to the drive to eject the removable disk drive 608.

In alternative embodiments, the eject service 606 recognizes the insertion of a removable disk drive 608 into a drive port 110 (FIG. 1). During the initialization of the removable disk drive 608, the eject service 606 issues a lock command to the eject service 606 or the drive port 110 (FIG. 1). The lock command prevents the ejection of the device. The lock command is important for file systems that allow a user to eject the removable disk drive 608 using a mechanical button regardless of what operation the removable disk drive 608 is currently performing. As such, the eject service 606 can prevent data corruption even for operating systems that allow certain types of mechanical eject operations.

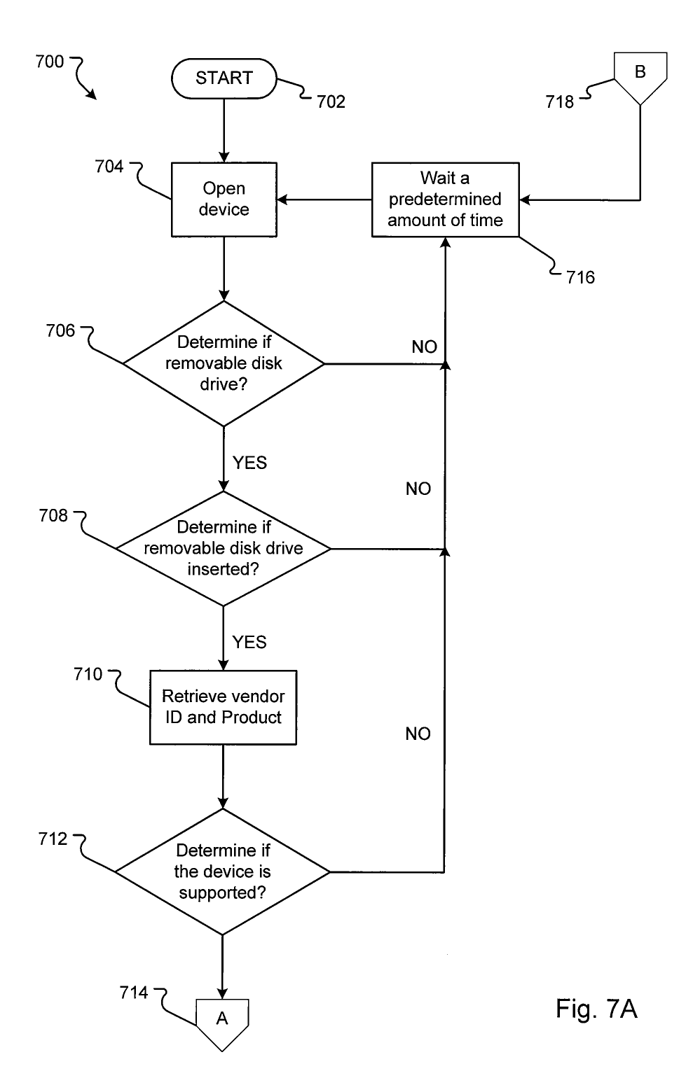

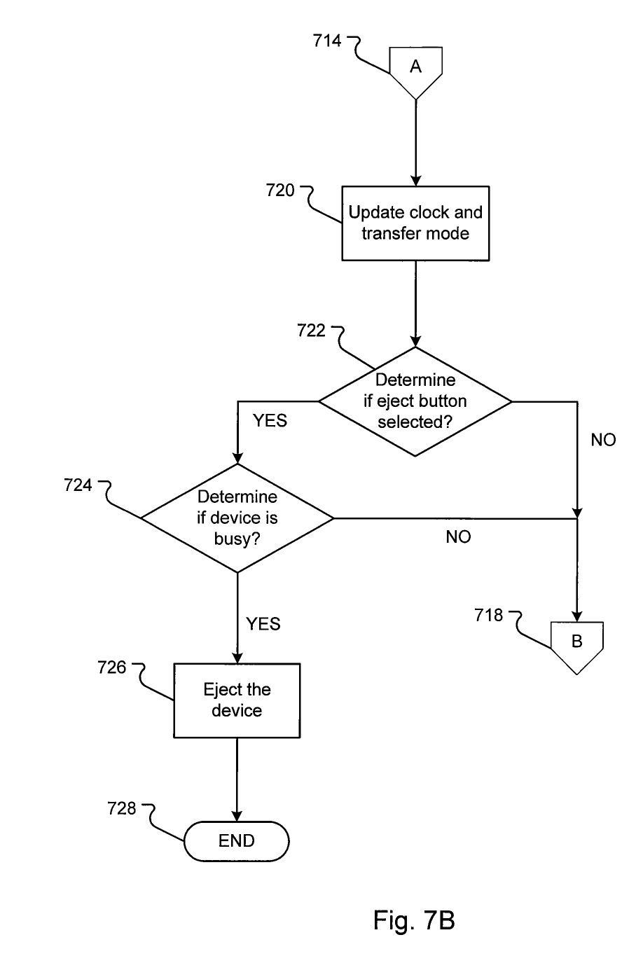

An embodiment of a method 700 for ejecting a removable disk drive is shown in FIGS. 7A & 7B. In embodiments, the method 700 generally begins with a START operation 702 and terminates with an END operation 728. The steps shown in the method 700 may be executed in a computer system as a set of computer executable instructions. While a logical order is shown in FIG. 7, the steps shown or described can, in some circumstances, be executed in a different order than presented herein. The method 700, in embodiments, relates to the eject service 606 described in conjunction with FIGS. 6A & 6B. The method 700, in embodiments, relates to an eject operation 610 (FIG. 6) completed in response to the activation of a mechanical eject button on a drive port 110 (FIG. 1).

Open operation 704 opens the device. In embodiments, the eject service 606 (FIG. 6) opens the device to communicate with device. For example, the eject service 606 (FIG. 6) uses the PhysicalDrive access to open the drive. Using PhysicalDrive prevents an operating system operation. such as a Microsoft® Windows® operation, from sending write directives to the drive and slowing operations being completed by the drive. Further, using PhysicalDrive also allows the eject service 606 (FIG. 6) to communicate with the drive even if Windows or the operating system cannot communicate with the drive.

Determine operation 706 determines if the drive opened is a removable disk drive 102 (FIG. 1). In embodiments, the eject service 606 (FIG. 6) determines if the opened device is a removable disk drive 102 (FIG. 1). The eject service 606 (FIG. 6) may access data stored about the removable disk drive 102 (FIG. 1) in the database 318 (FIG. 3) or in data stored resident with the eject service 606 (FIG. 6). In other embodiments, the eject service 606 (FIG. 6) communicates with the device and receives information that identifies the device as a removable disk drive 102 (FIG. 1). If the device is a removable disk drive 102 (FIG. 1), the method flows YES to determine operation 708. If the device is not a removable disk drive 102 (FIG. 1), the method flows NO to wait operation 716. In alternative embodiments, another operation may also be completed before or after the wait operation 716 if the device is not a removable disk drive 102 (FIG. 1).

Determine operation 708 determines if a removable disk drive 102 (FIG. 1) is inserted. In embodiments, the eject service 606 (FIG. 6) determines if an identified removable disk drive 102 (FIG. 1) is inserted into the drive. In embodiments, the eject service 606 (FIG. 6) communicates with the removable disk drive 102 (FIG. 1) and receives information that indicates that the removable disk drive 102 (FIG. 1) is inserted in the drive. If the removable disk drive 102 (FIG. 1) is inserted, the method flows YES to retrieve operation 710. If the removable disk drive 102 (FIG. 1) is not inserted, the method flows NO to wait operation 716. In embodiments, the eject service 606 (FIG. 6) uses the IOCT_STORAGE_GET_MEDIATYPES_EX command to determine if the removable disk drive 102 (FIG. 1) is inserted. Unlike the TEST UNIT READY command, the IOCT_STORAGE_GET_MEDIATYPES_EX does not steal UNIT_ATTENTION from the removable disk drive 102 (FIG. 1) if the removable disk drive 102 (FIG. 1) was recently inserted.

Retrieve operation 710 retrieves the information about the removable disk drive 102 (FIG. 1). In embodiments, the information includes the vendor identifier (ID) and/or product information. The eject service 606 (FIG. 6), in embodiments, retrieves the vendor identifier and/or product information, for example, the type of removable disk drive 102 (FIG. 1), capacity, date created, etc. The retrieved information may be retrieved from a database, for example, the database 318 (FIG. 3), or in data stored resident with the eject service 606 (FIG. 6). Alternatively, the eject service 606 (FIG. 6) may access metadata stored on the removable disk drive 102 (FIG. 1). In embodiments, the eject service 606 (FIG. 6) retrieves the vendor ID and the product information using the IOCTL command to the device driver.

Determine operation 712 determines if the device is supported. In embodiments, the eject service 606 (FIG. 6) uses the vendor identifier and/or the product information to determine if the removable disk drive 102 (FIG. 1) is supported by the eject service 606 (FIG. 6). For example, the eject service 606 (FIG. 6) determines if the drivers exist for the removable disk drive 102 (FIG. 1). If the removable disk drive 102 (FIG. 1) is supported, the method flows YES through connector A 714 to update operation 720 shown in FIG. 7B. If the removable disk drive 102 (FIG. 1) is not supported, the method flows NO through connector B 718 to wait operation 716.

Wait operation 716 waits a predetermined period of time. The period of time may be a second, minute, hour, or other unit of time. In embodiments, the wait operation 716 allows the eject service 606 (FIG. 6) to sleep for some time before retrying the operation. For example, the removable disk drive 102 (FIG. 1) may not have been inserted and then is inserted, and the operation can then be completed after waiting the predetermined period of time. Thus, cycling through the wait operation 716 creates a loop that retries operations when not allowed for one reason or another.

Update operation 720 updates the clock and transfer mode. In embodiments, the eject service 606 (FIG. 6) updates data used by the eject service 606 (FIG. 6). Thus, the eject service 606 (FIG. 6) stores the current status of the clock for the removable disk drive 102 (FIG. 1) and the transfer mode condition of the removable disk drive 102 (FIG. 1). The data may be stored in a temporary memory structure. The transfer mode, in embodiments, is the ultra direct memory access (UDMA) mode. The clock may be the removable disk drive's 102 (FIG. 1) real time clock.

Determine operation 722 determines if the eject button is selected. The eject service 606 (FIG. 6) can determine if the eject button was activated. The eject button is, in embodiments, a mechanical device physically pushed by a user. In embodiments, the eject service 606 (FIG. 6) uses the small computer system interface (SCSI) GET_EVENT_STATUS command to determine if the eject button was selected. If the eject button was selected, the method flows YES to determine operation 724. If the eject button was not selected, the method flows NO through connector B 718 to wait operation 716 shown in FIG. 7A.

Determine operation 724 determines if the device is busy. In embodiments, the eject service 606 (FIG. 6) uses the UDMA transfer mode updated in update operation 720 to determine the status of the removable disk drive 102 (FIG. 1). In other embodiments, the eject service 606 (FIG. 6) requests the current status from the removable disk drive 102 (FIG. 1). If the removable disk drive 102 (FIG. 1) is not busy, the method flows YES to eject operation 710. If the removable disk drive 102 (FIG. 1) is busy, the method flows NO through connector B 718 to wait operation 716 shown in FIG. 7A.

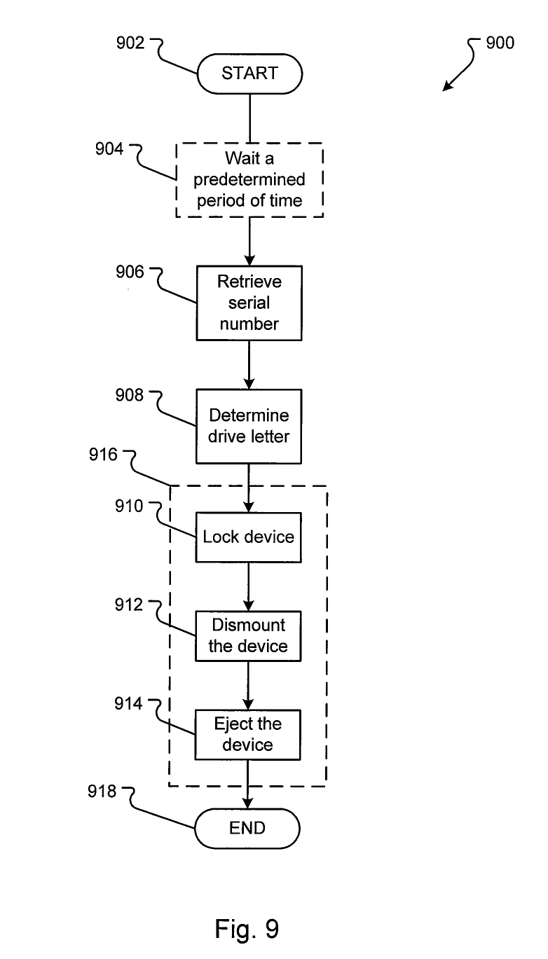

Eject operation 726 ejects the device. The eject service 606 (FIG. 6) can send an eject command 610 (FIG. 6) to the drive to eject the removable disk drive 102 (FIG. 1). The drive can then eject the removable disk drive 102 (FIG. 1) in response to the command. An embodiment of an eject operation 726 is described in conjunction with FIG. 9.

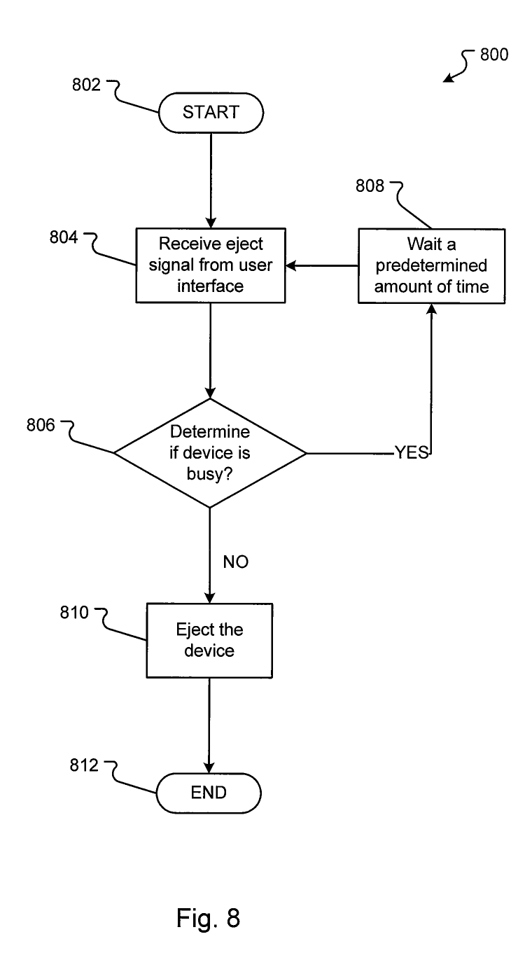

An embodiment of a method 800 for ejecting a removable disk drive is shown in FIG. 8. In embodiments, the method 800 generally begins with a START operation 802 and terminates with an END operation 812. The steps shown in the method 800 may be executed in a computer system as a set of computer executable instructions. While a logical order is shown in FIG. 8, the steps shown or described can, in some circumstances, be executed in a different order than presented herein. The method 800, in embodiments, relates to the eject service 606 described in conjunction with FIGS. 6A & 6B. The method 800, in embodiments, relates to an eject operation completed in response to the selection, in a user interface, a eject user interface device, for example, a menu item, an icon, etc.

Receive operation 804 receives an eject signal from a user interface. In embodiment, the user selects a user interface device, for example, a menu item, an icon, etc., to eject the removable disk drive 102 (FIG. 1). The shell extension 604 (FIG. 6) can intercept the selection signal and instantiate the eject service 606 (FIG. 6). The eject service 606 (FIG. 6) may then function to complete the eject. The eject service 606 (FIG. 6) allows a user to eject the removable disk drive 102 (FIG. 1) with operating systems that may not be operable to eject the removable disk drive 102 (FIG. 1).

Determine operation 806 determines if the device is busy. In embodiments, the eject service 606 (FIG. 6) requests the current status from the removable disk drive 102 (FIG. 1). In other embodiments, the eject service 606 (FIG. 6) attempts to send an eject command to the removable disk drive 102 (FIG. 1) and may receive an error because the removable disk drive 102 (FIG. 1) is busy. If the removable disk drive 102 (FIG. 1) is not busy, the method flows YES to eject operation 810. If the removable disk drive 102 (FIG. 1) is busy, the method flows NO through connector B 718 to wait operation 716 shown in FIG. 7A.

Wait operation 808 waits a predetermined period of time. The period of time may be a second, minute, hour, or other unit of time. In embodiments, the wait operation 808 allows the eject service 606 (FIG. 6) to sleep for some time before retrying the operation. For example, the removable disk drive 102 (FIG. 1) may be busy completing a write operation, and the eject can be completed after waiting the predetermined period of time. Thus, cycling through the wait operation 808 creates a loop that retries operations when not allowed for one reason or another. In embodiments, after the wait operation 808, the eject service 606 (FIG. 6) waits for another eject signal from the operating system. In alternative embodiments, the eject service 606 (FIG. 6) alerts the operating system of the failed eject. The operating system can alert the user, through a display on the user interface, that the eject signal or eject selection failed. The user may then retry the eject.

Eject operation 726 (FIG. 7B) ejects the device. The eject service 606 (FIG. 6) can send an eject command to the drive to eject the removable disk drive 102 (FIG. 1). The drive can then eject the removable disk drive 102 (FIG. 1) in response to the command. An embodiment of an eject operation 726 (FIG. 7B) is described in conjunction with FIG. 9.

An embodiment of a method 900 for ejecting a removable disk drive is shown in FIG. 9. In embodiments, the method 900 generally begins with a START operation 902 and terminates with an END operation 918. The steps shown in the method 900 may be executed in a computer system as a set of computer executable instructions. While a logical order is shown in FIG. 9, the steps shown or described can, in some circumstances, be executed in a different order than presented herein. The method 900, in embodiments, relates to the eject service 606 described in conjunction with FIGS. 6A & 6B. The method 900, in embodiments, relates to an eject operation 726 (FIG. 7B) and/or 810 (FIG. 8).

Wait operation 904 waits a predetermined period of time. The period of time may be a second, minute, hour, or other unit of time. In embodiments, the wait operation 904 allows the operating system to detect the insertion of the removable disk drive 102 (FIG. 1), if the removable disk drive 102 (FIG. 1) was just inserted into the drive. For example, the removable disk drive 102 (FIG. 1) may not have been inserted and then is inserted, and the removable disk drive 102 (FIG. 1) is detected after waiting the predetermined period of time.

Retrieve operation 906 retrieves the serial number. The eject service 606 (FIG. 6), in embodiments, retrieves the serial number. The retrieved serial number may be retrieved from the database 318 (FIG. 3) or in data stored resident with the eject service 606 (FIG. 6). Alternatively, the eject service 606 (FIG. 6) may access metadata stored on the removable disk drive 102 (FIG. 1). In embodiments, the eject service 606 (FIG. 6) retrieves the serial number based on the PhysicalDrive operation.

Determine operation 908 determines the drive letter. In embodiments, the eject service 606 (FIG. 6) determines the drive letter from the serial number or other information. The drive letter may be associated with the serial number or other data in the database or in data stored resident with the eject service 606 (FIG. 6). Alternatively, the eject service 606 (FIG. 6) may access metadata stored on the removable disk drive 102 (FIG. 1) and lookup the drive letter using the serial number.

In embodiments, the eject service 606 (FIG. 6) sends an atomic command, represented by the box 916, that completes the lock operation 910, the dismount operation 912, and the eject operation 914. The lock operation 910 locks the removable disk drive 102 (FIG. 1). The dismount operation 912 dismounts the removable disk drive 102 (FIG. 1). Finally, the ejection operation 914 physically ejects the removable disk drive 102 (FIG. 1) from the drive port 110 (FIG. 1).

Specific details were given in the preceding description to provide a thorough understanding of the embodiments. However, it will be understood by one of ordinary skill in the art that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments. A computing system may be used to execute any of the tasks or operations described herein. In embodiments, a computing system includes memory and a processor and is operable to execute computer-executable instructions stored on a computer readable medium that define processes or operations described herein.

Also, it is noted that the embodiments can also be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in the figure. A process may correspond to a method, a function, a procedure, a subroutine, a subprogram, etc. When a process corresponds to a function, its termination corresponds to a return of the function to the calling function or the main function.

Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine-readable mediums for storing information. The term “machine-readable medium” includes, but is not limited to, portable or fixed storage devices, optical storage devices, wireless channels and various other mediums capable of storing, containing or carrying instruction(s) and/or data.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine-readable medium such as a storage medium. A processor(s) may perform the necessary tasks. A code segment may represent a procedure, a function, a subprogram, a program, a routine, a subroutine, a module, an object, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

In light of the above description, a number of advantages of the present disclosure are readily apparent. For example, the eject service and shell extension can eject a removable disk drive even if a server uses an operating system that may not be capable of the eject. Further, if the removable disk drive is busy performing an operation, the eject service waits for the operation to complete before ejecting the removable disk drive. Thus, the eject service prevents an eject occurring when the eject could create corrupt or lost data.

A number of variations and modifications of the disclosure can also be used. For example, the user may be given a message about the eject request and how, if completed, the eject will cause data loss. The user may be able to select to continue regardless of the problems that the eject may cause.

It will be apparent to those skilled in the art that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

While the principles of the disclosure have been described above in connection with specific apparatuses and methods, it is to be clearly understood that this description is made only by way of example and not as limitation on the scope of the disclosure.

What is claimed is:

1. A method, executable in a computer system, for protecting the integrity of data when a manual eject button is activated for a device, the method comprising:
determining if the device is a removable disk drive;
determining if the removable disk drive is busy;
if the removable disk drive is busy, waiting a period of time; and
if the removable disk drive is not busy, ejecting the removable disk drive.

2. The method as defined in claim 1, wherein determining if the device includes accessing information on the removable disk drive.

3. The method as defined in claim 1, further comprising determining if an eject button was pushed.

4. The method as defined in claim 1, wherein ejecting the removable disk drive comprises sending a sequence of commands.

5. The method as defined in claim 4, wherein the sequence of commands comprises:
locking the removable disk drive;
dismounting the removable disk drive; and
physically ejecting the removable disk drive.

6. The method as defined in claim 1, further comprising intercepting an eject command at an eject service.

7. The method as defined in claim 6, wherein the eject service intercepts the eject command issued by an operating system in response to an eject signal from an eject button.

8. The method as defined in claim 1, further comprising ejecting the removable disk drive after the period of time.

9. A server system operable to eject a removable disk drive from an archiving system, the server system comprising:
a processor operable to execute one or more instructions;
a memory in communication with the processor, the memory storing the one or more instructions executed by the processor, the instructions operable to execute one or more software components, the software components comprising:
an operating system, the operating system operable to receive a first eject signal from a user interface associated with a removable disk drive, the operating system operable to receive a second eject signal from an eject button associated with the removable disk drive;
a shell extension, the shell extension in communication with the operating system, the shell extension operable to intercept the first eject signal or the second eject signal; and
an eject service in communication with the shell extension, the eject service operable to receive the first intercepted eject signal or the second intercepted eject signal, the eject service operable to determine if the removable disk drive can be ejected, if the removable disk drive can be ejected, the eject service operable to eject the removable disk drive.

10. The server system as defined in claim 9, wherein in response to the second intercepted eject signal, the eject service opens the device, determines if the device is a removable disk drive, if the device is a removable disk drive, retrieves the information about the removable disk drive, determines if the removable disk drive is supported, if the removable disk drive is supported, determines if a eject button was selected, if the eject button was selected, determines if the removable disk drive is busy, and if the removable disk drive is not busy, ejects the removable disk drive.

11. The server system as defined in claim 9, wherein in response to the first intercepted eject signal, determines if the removable disk drive is busy, and if the removable disk drive is not busy, ejects the removable disk drive.

12. The server system as defined in claim 9, wherein the eject comprises:
locking the removable disk drive;
dismounting the removable disk drive; and
sending a command to physically eject the removable disk drive.

13. The server system as defined in claim 9, wherein the operating system cannot eject the removable disk drive without the eject service.

14. The server system as defined in claim 9, wherein the eject service waits a predetermined period of time if the removable disk drive cannot eject and attempts to eject again the removable disk drive after the predetermined period of time.

15. A server system operable to eject a removable disk drive from an archiving system, the server system comprising:
a processor operable to execute one or more instructions;
a memory in communication with the processor, the memory storing the one or more instructions executed by the processor, the instructions comprising:
instruction for receiving an eject signal from an operating system to eject a removable disk drive;
instructions for determining if the removable disk drive is busy;
if the device is not busy, instructions for ejecting the removable disk drive;
if the device is busy, instructions for waiting a predetermined period of time; and
instructions for receiving a next eject signal from the operating system.

16. The server system as defined in claim 15, wherein a shell extension intercepts the eject signal from the operating system and forwards the eject signal to an eject service to eject the removable disk drive.

17. The server system as defined in claim 16, wherein the operating system cannot eject the removable disk drive without the eject service.

18. The server system as defined in claim 15, wherein the instructions for ejecting the removable disk drive comprise instructions for sending a sequence of commands to eject the removable disk drive.

19. The server system as defined in claim 18, wherein the sequence of commands comprises:
instructions for locking the removable disk drive;
instructions for dismounting the removable disk drive; and
instructions for physically ejecting the removable disk drive from the drive port.

20. The server system as defined in claim 17, further comprising instructions to alert the user that the eject signal was unsuccessful.
